(19) United States
(12) Patent Application Publication
(10) Pub. No.: US 2023/0136731 A1
(43) Pub. Date: May 4, 2023

(54) BATTERY SYSTEM AND METHOD OF AN ELECTRIC AIRCRAFT WITH SPRING CONDUCTORS

(71) Applicant: BETA AIR, LLC, SOUTH BURLINGTON, VT (US)

(72) Inventor: Herman Wiegman, Essex Junction, VT (US)

(73) Assignee: BETA AIR, LLC, SOUTH BURLINGTON, VT (US)

(21) Appl. No.: 17/475,743

(22) Filed: Sep. 15, 2021

(51) Int. Cl. H01M 10/647; H01M 10/6551; H01M 10/625; B60L 58/26; B60L 50/64

(52) U.S. Cl. CPC H01M 10/647; H01M 10/6551; H01M 10/625; B60L 58/26; B60L 50/64; B60L 2200/10; H01M 2220/20

(57) ABSTRACT

A system for a battery with spring conductors is illustrated. The system comprises a case, a plurality of battery cells, and a lid. The case is coupled to the aircraft and comprises a thermal conducting interior surface. The plurality of battery cells are inserted into the case in layers and comprises a thermally conducting fin contacting the thermally conducting interior surface, a pouch cell, and a vent configured to vent ejecta from the pouch cell. The pouch cell comprises a pair of electrodes, a pair of foil tabs electrically connected to the electrodes, an insulator layer located between the pair of foil tabs, a pouch encompassing the pair of foil tabs and the insulation layer, and an electrolyte within the pouch. The lid is configured to interact with the case.

### FIELD OF THE INVENTION

The present invention generally relates to the field of electric aircrafts. In particular, the present invention is directed to a battery system with spring conductors of an electric aircraft.

### BACKGROUND

When operating, both a motor and a battery generate lots of heat, which, if not vented properly, can cause damage and harm to the aircraft and its occupants. Improvements in battery cell insulation with fins can help make the aircraft battery and motor more reliable and allow a more desirable flight experience.

### SUMMARY OF THE DISCLOSURE

In an aspect, a system for a battery with spring conductors is illustrated. The system comprises a case, a plurality of battery cells, and a lid. The case is coupled to the aircraft and comprises a thermal conducting interior surface. The plurality of battery cells are inserted into the case in layers and comprises a thermally conducting fin contacting the thermally conducting interior surface, a pouch cell, and a vent configured to vent ejecta from the pouch cell. The pouch cell comprises a pair of electrodes, a pair of foil tabs electrically connected to the electrodes, an insulator layer located between the pair of foil tabs, a pouch encompassing the pair of foil tabs and the insulation layer, and an electrolyte within the pouch. The lid is configured to interact with the case.

In another aspect, a method for a battery system with spring conductors of an electric aircraft is illustrated. The method includes configuring a case comprising a thermally conducting interior surface, inserting a plurality of battery cells into the case by layers, contacting, at each battery cell, a thermally conducting fin to the thermally conducting interior surface, comprising, at each battery cell, a pouch cell, comprising, at each battery cell, a vent configured to vent the ejecta from the pouch cell, and interacting a lid with the case.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a diagrammatic representation of an exemplary embodiment of an electric aircraft;

FIG. 2 is a diagrammatic representation of an exemplary embodiment of the case;

FIG. 3 is a diagram showing a possible embodiment of the plurality of battery cells;

FIG. 4 is a diagrammatic representation of an exemplary embodiment of the pouch cell;

FIG. 5 is a diagram showing a possible embodiment of the lid; and

FIG. 6 is a flow diagram of an exemplary embodiment of a method for a battery system with spring conductors of an electric aircraft.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

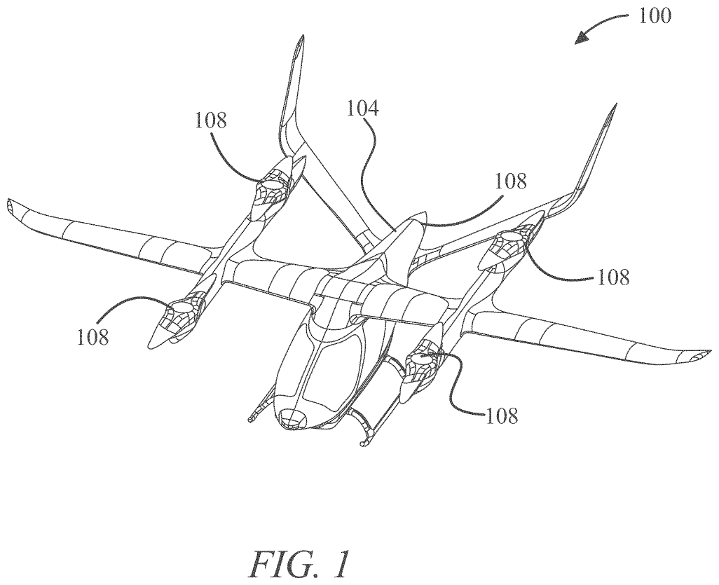

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At a high level, aspects of the present disclosure are directed to a charging system for an electric aircraft. In an embodiment, this disclosure includes an aircraft configured to include a fuselage and a plurality of flight components attached to the fuselage. Aspects of the present disclosure include at first battery comprising of a plurality of first battery cells, a plurality of second battery cells, and an electrical bridging device. Aspects of the present disclosure include at least a second battery coupled to the first battery. Aspects of the present disclosure include a computing device configured to detect a charge distance of the first battery, determine a charge deficiency as a function of the charge distance and a flight path, and charge the first battery using the at least a second battery as a function of the charge deficiency. Exemplary embodiments illustrating aspects of the present disclosure are described below in the context of several specific examples.

Referring now to FIG. 1, an exemplary embodiment of an aircraft 100 is illustrated. In an embodiment, aircraft 100 is an electric aircraft. As used in this disclosure an “aircraft” is any vehicle that may fly by gaining support from the air. As a non-limiting example, aircraft may include airplanes, helicopters, commercial and/or recreational aircrafts, instrument flight aircrafts, drones, electric aircrafts, airliners, rotorcrafts, vertical takeoff and landing aircrafts, jets, airships, blimps, gliders, paramotors, and the like. Aircraft 100 may include an electrically powered aircraft. In embodiments, electrically powered aircraft may be an electric vertical takeoff and landing (eVTOL) aircraft. Electric aircraft may be capable of rotor-based cruising flight, rotor-based takeoff, rotor-based landing, fixed-wing cruising flight, airplane-style takeoff, airplane-style landing, and/or any combination thereof. Electric aircraft may include one or more manned and/or unmanned aircrafts. Electric aircraft may include one or more all-electric short takeoff and landing (eSTOL) aircrafts. For example, and without limitation, eSTOL aircrafts may accelerate plane to a flight speed on takeoff and decelerate plane after landing. In an embodiment, and without limitation, electric aircraft may be configured with an electric propulsion assembly. Electric propulsion assembly may include any electric propulsion assembly as described in U.S. Nonprovisional application Ser. No. 16/603,225, filed on Dec. 4, 2019, and entitled “AN INTEGRATED ELECTRIC PROPULSION ASSEMBLY,” the entirety of which is incorporated herein by reference.

Still referring to FIG. 1, aircraft 100, may include a fuselage 104 and a flight component 108 (or one or more flight components 108).

As used in this disclosure, a vertical take-off and landing (VTOL) aircraft is an aircraft that can hover, take off, and land vertically. An eVTOL, as used in this disclosure, is an electrically powered aircraft typically using an energy source, of a plurality of energy sources to power aircraft. To optimize the power and energy necessary to propel aircraft 100, eVTOL may be capable of rotor-based cruising flight, rotor-based takeoff, rotor-based landing, fixed-wing cruising flight, airplane-style takeoff, airplane style landing, and/or any combination thereof. Rotor-based flight, as described herein, is where the aircraft generates lift and propulsion by way of one or more powered rotors or blades coupled with an engine, such as a “quad-copter,” multi-rotor helicopter, or other vehicle that maintains its lift primarily using downward thrusting propulsors. “Fixed-wing flight”, as described herein, is where an aircraft is capable of flight using wings and/or foils that generate lift caused by the aircraft's forward airspeed and the shape of the wings and/or foils, such as airplane-style flight.

Still referring to FIG. 1, as used in this disclosure a “fuselage” is a main body of an aircraft, or in other words, the entirety of the aircraft except for a cockpit, nose, wings, empennage, nacelles, any and all control surfaces, and generally contains an aircraft's payload. Fuselage 104 may include structural elements that physically support a shape and structure of an aircraft. Structural elements may take a plurality of forms, alone or in combination with other types. Structural elements may vary depending on a construction type of aircraft such as without limitation a fuselage 104. Fuselage 104 may comprise a truss structure. A truss structure may be used with a lightweight aircraft and comprises welded steel tube trusses. A “truss,” as used in this disclosure, is an assembly of beams that create a rigid structure, often in combinations of triangles to create three-dimensional shapes. A truss structure may alternatively comprise wood construction in place of steel tubes, or a combination thereof. In embodiments, structural elements may comprise steel tubes and/or wood beams. In an embodiment, and without limitation, structural elements may include an aircraft skin. Aircraft skin may be layered over the body shape constructed by trusses. Aircraft skin may comprise a plurality of materials such as plywood sheets, aluminum, fiberglass, and/or carbon fiber, the latter of which will be addressed in greater detail later herein.

In embodiments, and with continued reference to FIG. 1, aircraft fuselage 104 may include and/or be constructed using geodesic construction. Geodesic structural elements may include stringers wound about formers (which may be alternatively called station frames) in opposing spiral directions. A “stringer,” as used in this disclosure, is a general structural element that may include a long, thin, and rigid strip of metal or wood that is mechanically coupled to and spans a distance from, station frame to station frame to create an internal skeleton on which to mechanically couple aircraft skin. A former (or station frame) may include a rigid structural element that is disposed along a length of an interior of aircraft fuselage 104 orthogonal to a longitudinal (nose to tail) axis of the aircraft and may form a general shape of fuselage 104. A former may include differing cross-sectional shapes at differing locations along fuselage 104, as the former is a structural element that informs the overall shape of a fuselage 104 curvature. In embodiments, aircraft skin may be anchored to formers and strings such that an outer mold line of a volume encapsulated by formers and stringers comprises the same shape as aircraft 100 when installed. In other words, former(s) may form a fuselage's ribs, and the stringers may form the interstitials between such ribs. A spiral orientation of stringers about formers may provide uniform robustness at any point on an aircraft fuselage such that if a portion sustains damage, another portion may remain largely unaffected. Aircraft skin may be attached to underlying stringers and formers and may interact with a fluid, such as air, to generate lift and perform maneuvers.

In an embodiment, and still referring to FIG. 1, fuselage 104 may include and/or be constructed using monocoque construction. Monocoque construction may include a primary structure that forms a shell (or skin in an aircraft's case) and supports physical loads. Monocoque fuselages are fuselages in which an aircraft skin or shell is also the primary structure. In monocoque construction aircraft skin would support tensile and compressive loads within itself and true monocoque aircraft can be further characterized by the absence of internal structural elements. Aircraft skin in this construction method is rigid and can sustain its shape with no structural assistance form underlying skeleton-like elements. Monocoque fuselage may include aircraft skin made from plywood layered in varying grain directions, epoxy-impregnated fiberglass, carbon fiber, or any combination thereof.

According to embodiments, and further referring to FIG. 1, fuselage 104 may include a semi-monocoque construction. Semi-monocoque construction, as used herein, is a partial monocoque construction, wherein a monocoque construction is describe above detail. In semi-monocoque construction, aircraft fuselage 104 may derive some structural support from stressed aircraft skin and some structural support from underlying frame structure made of structural elements. Formers or station frames can be seen running transverse to the long axis of fuselage 104 with circular cutouts which are generally used in real-world manufacturing for weight savings and for the routing of electrical harnesses and other modern on-board systems. In a semi-monocoque construction, stringers are thin, long strips of material that run parallel to fuselage's long axis. Stringers may be mechanically coupled to formers permanently, such as with rivets. Aircraft skin may be mechanically coupled to stringers and formers permanently, such as by rivets as well. A person of ordinary skill in the art will appreciate, upon reviewing the entirety of this disclosure, that there are numerous methods for mechanical fastening of components like screws, nails, dowels, pins, anchors, adhesives like glue or epoxy, or bolts and nuts, to name a few. A subset of fuselage under the umbrella of semi-monocoque construction includes unibody vehicles. Unibody, which is short for “unitized body” or alternatively “unitary construction”, vehicles are characterized by a construction in which the body, floor plan, and chassis form a single structure. In the aircraft world, unibody may be characterized by internal structural elements like formers and stringers being constructed in one piece, integral to the aircraft skin as well as any floor construction like a deck.

Still referring to FIG. 1, stringers and formers, which may account for the bulk of an aircraft structure excluding monocoque construction, may be arranged in a plurality of orientations depending on aircraft operation and materials. Stringers may be arranged to carry axial (tensile or compressive), shear, bending or torsion forces throughout their overall structure. Due to their coupling to aircraft skin, aerodynamic forces exerted on aircraft skin will be transferred to stringers. A location of said stringers greatly informs the type of forces and loads applied to each and every stringer, all of which may be handled by material selection, cross-sectional area, and mechanical coupling methods of each member. A similar assessment may be made for formers. In general, formers may be significantly larger in cross-sectional area and thickness, depending on location, than stringers. Both stringers and formers may comprise aluminum, aluminum alloys, graphite epoxy composite, steel alloys, titanium, or an undisclosed material alone or in combination.

In an embodiment, and still referring to FIG. 1, stressed skin, when used in semi-monocoque construction is a concept where skin of an aircraft bears partial, yet significant, load in an overall structural hierarchy. In other words, an internal structure, whether it be a frame of welded tubes, formers and stringers, or some combination, may not be sufficiently strong enough by design to bear all loads. The concept of stressed skin may be applied in monocoque and semi-monocoque construction methods of fuselage 104. Monocoque comprises only structural skin, and in that sense, aircraft skin undergoes stress by applied aerodynamic fluids imparted by the fluid. Stress as used in continuum mechanics may be described in pound-force per square inch (lbf/in²) or Pascals (Pa). In semi-monocoque construction stressed skin may bear part of aerodynamic loads and additionally may impart force on an underlying structure of stringers and formers.

Still referring to FIG. 1, it should be noted that an illustrative embodiment is presented only, and this disclosure in no way limits the form or construction method of a system and method for loading payload into an eVTOL aircraft. In embodiments, fuselage 104 may be configurable based on needs of an eVTOL per specific mission or objective. A general arrangement of components, structural elements, and hardware associated with storing and/or moving a payload may be added or removed from fuselage 104 as needed, whether it is stowed manually, automatedly, or removed by personnel altogether. Fuselage 104 may be configurable for a plurality of storage options. Bulkheads and dividers may be installed and uninstalled as needed, as well as longitudinal dividers where necessary. Bulkheads and dividers may be installed using integrated slots and hooks, tabs, boss and channel, or hardware like bolts, nuts, screws, nails, clips, pins, and/or dowels, to name a few. Fuselage 104 may also be configurable to accept certain specific cargo containers, or a receptable that can, in turn, accept certain cargo containers.

Still referring to FIG. 1, aircraft 100 may include a plurality of laterally extending elements attached to fuselage 104. As used in this disclosure a “laterally extending element” is an element that projects essentially horizontally from fuselage, including an outrigger, a spar, and/or a fixed wing that extends from fuselage. Wings may be structures which may include airfoils configured to create a pressure differential resulting in lift. Wings may generally dispose on the left and right sides of the aircraft symmetrically, at a point between nose and empennage. Wings may comprise a plurality of geometries in planform view, swept swing, tapered, variable wing, triangular, oblong, elliptical, square, among others. A wing's cross section geometry may comprise an airfoil. An “airfoil” as used in this disclosure is a shape specifically designed such that a fluid flowing above and below it exert differing levels of pressure against the top and bottom surface. In embodiments, the bottom surface of an aircraft can be configured to generate a greater pressure than does the top, resulting in lift. Laterally extending element may comprise differing and/or similar cross-sectional geometries over its cord length or the length from wing tip to where wing meets aircraft's body. One or more wings may be symmetrical about aircraft's longitudinal plane, which comprises the longitudinal or roll axis reaching down the center of aircraft through the nose and empennage, and plane's yaw axis. Laterally extending element may comprise controls surfaces configured to be commanded by a pilot or pilots to change a wing's geometry and therefore its interaction with a fluid medium, like air. Control surfaces may comprise flaps, ailerons, tabs, spoilers, and slats, among others. Control surfaces may dispose on the wings in a plurality of locations and arrangements and in embodiments may be disposed at the leading and trailing edges of the wings, and may be configured to deflect up, down, forward, aft, or a combination thereof. An aircraft, including a dual-mode aircraft may comprise a combination of control surfaces to perform maneuvers while flying or on ground.

Still referring to FIG. 1, aircraft 100 may include a plurality of flight components 108. As used in this disclosure a “flight component” is a component that promotes flight and guidance of an aircraft. In an embodiment, flight component 108 may be mechanically coupled to an aircraft. As used herein, a person of ordinary skill in the art would understand “mechanically coupled” to mean that at least a portion of a device, component, or circuit is connected to at least a portion of the aircraft via a mechanical coupling. Said mechanical coupling may include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. In an embodiment, mechanical coupling may be used to connect ends of adjacent parts and/or objects of an electric aircraft. Further, in an embodiment, mechanical coupling may be used to join two pieces of rotating electric aircraft components.

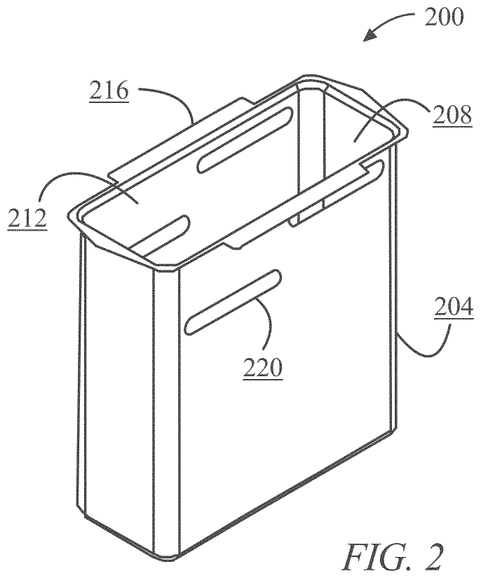

Still referring to FIG. 1, plurality of flight components 108 may include at least a lift propulsor. As used in this disclosure a “propulsor” is a component and/or device used to propel a craft upward by exerting force on a fluid medium, which may include a gaseous medium such as air or a liquid medium such as water. Propulsor may include any device or component that consumes electrical power on demand to propel an electric aircraft in a direction or other vehicle while on ground or in-flight. For example, and without limitation, propulsor may include a rotor, propeller, paddle wheel and the like thereof. In an embodiment, propulsor may include a plurality of blades. As used in this disclosure a “blade” is a propeller that converts rotary motion from an engine or other power source into a swirling slipstream. In an embodiment, blade may convert rotary motion to push the propeller forwards or backwards. In an embodiment propulsor may include a rotating power-driven hub, to which are attached several radial airfoil-section blades such that the whole assembly rotates about a longitudinal axis. A lift propulsor is further described herein with reference to FIG. 2.

In an embodiment, and still referring to FIG. 1, plurality of flight components 108 may include one or more power sources. As used in this disclosure a “power source” is a source that that drives and/or controls any other flight component. For example, and without limitation power source may include a motor that operates to move one or more lift propulsor components, to drive one or more blades, or the like thereof. A motor may be driven by direct current (DC) electric power and may include, without limitation, brushless DC electric motors, switched reluctance motors, induction motors, or any combination thereof. A motor may also include electronic speed controllers or other components for regulating motor speed, rotation direction, and/or dynamic braking. In an embodiment, power source may include an inverter. As used in this disclosure an “inverter” is a device that changes one or more currents of a system. For example, and without limitation, inverter may include one or more electronic devices that change direct current to alternating current. As a further non-limiting example, inverter may include receiving a first input voltage and outputting a second voltage, wherein the second voltage is different from the first voltage. In an embodiment, and without limitation, inverter may output a waveform, wherein a waveform may include a square wave, sine wave, modified sine wave, near sine wave, and the like thereof.

Still referring to FIG. 1, power source may include an energy source. An energy source may include, for example, a generator, a photovoltaic device, a fuel cell such as a hydrogen fuel cell, direct methanol fuel cell, and/or solid oxide fuel cell, an electric energy storage device (e.g. a capacitor, an inductor, and/or a battery). An energy source may also include a battery cell, or a plurality of battery cells connected in series into a module and each module connected in series or in parallel with other modules. Configuration of an energy source containing connected modules may be designed to meet an energy or power requirement and may be designed to fit within a designated footprint in an electric aircraft in which aircraft 100 may be incorporated.

In an embodiment, and still referring to FIG. 1, an energy source may be used to provide a steady supply of electrical power to a load over the course of a flight by a vehicle or other electric aircraft. For example, the energy source may be capable of providing sufficient power for “cruising” and other relatively low-energy phases of flight. An energy source may also be capable of providing electrical power for some higher-power phases of flight as well, particularly when the energy source is at a high SOC, as may be the case for instance during takeoff. In an embodiment, the energy source may be capable of providing sufficient electrical power for auxiliary loads including without limitation, lighting, navigation, communications, de-icing, steering or other systems requiring power or energy. Further, the energy source may be capable of providing sufficient power for controlled descent and landing protocols, including, without limitation, hovering descent or runway landing. As used herein the energy source may have high power density where the electrical power an energy source can usefully produce per unit of volume and/or mass is relatively high. The electrical power is defined as the rate of electrical energy per unit time. An energy source may include a device for which power that may be produced per unit of volume and/or mass has been optimized, at the expense of the maximal total specific energy density or power capacity, during design. Non-limiting examples of items that may be used as at least an energy source may include batteries used for starting applications including Li ion batteries which may include NCA, NMC, Lithium iron phosphate (LiFePO4) and Lithium Manganese Oxide (LMO) batteries, which may be mixed with another cathode chemistry to provide more specific power if the application requires Li metal batteries, which have a lithium metal anode that provides high power on demand, Li ion batteries that have a silicon or titanite anode, energy source may be used, in an embodiment, to provide electrical power to an electric aircraft or drone, such as an electric aircraft vehicle, during moments requiring high rates of power output, including without limitation takeoff, landing, thermal de-icing and situations requiring greater power output for reasons of stability, such as high turbulence situations, as described in further detail below. A battery may include, without limitation a battery using nickel based chemistries such as nickel cadmium or nickel metal hydride, a battery using lithium ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO), a battery using lithium polymer technology, lead-based batteries such as without limitation lead acid batteries, metal-air batteries, or any other suitable battery. Persons skilled in the art, upon reviewing the entirety of this disclosure, will be aware of various devices of components that may be used as an energy source.

Still referring to FIG. 1, an energy source may include a plurality of energy sources, referred to herein as a module of energy sources. The module may include batteries connected in parallel or in series or a plurality of modules connected either in series or in parallel designed to deliver both the power and energy requirements of the application. Connecting batteries in series may increase the voltage of at least an energy source which may provide more power on demand. High voltage batteries may require cell matching when high peak load is needed. As more cells are connected in strings, there may exist the possibility of one cell failing which may increase resistance in the module and reduce the overall power output as the voltage of the module may decrease as a result of that failing cell. Connecting batteries in parallel may increase total current capacity by decreasing total resistance, and it also may increase overall amp-hour capacity. The overall energy and power outputs of at least an energy source may be based on the individual battery cell performance or an extrapolation based on the measurement of at least an electrical parameter. In an embodiment where the energy source includes a plurality of battery cells, the overall power output capacity may be dependent on the electrical parameters of each individual cell. If one cell experiences high self-discharge during demand, power drawn from at least an energy source may be decreased to avoid damage to the weakest cell. The energy source may further include, without limitation, wiring, conduit, housing, cooling system and battery management system. Persons skilled in the art will be aware, after reviewing the entirety of this disclosure, of many different components of an energy source.

Still referring to FIG. 1, plurality of flight components 108 may include a pusher component. As used in this disclosure a “pusher component” is a component that pushes and/or thrusts an aircraft through a medium. As a non-limiting example, pusher component may include a pusher propeller, a paddle wheel, a pusher motor, a pusher propulsor, and the like. Additionally, or alternatively, pusher flight component may include a plurality of pusher flight components. Pusher component may be configured to produce a forward thrust. As used in this disclosure a “forward thrust” is a thrust that forces aircraft through a medium in a horizontal direction, wherein a horizontal direction is a direction parallel to the longitudinal axis. For example, forward thrust may include a force of 1145 N to force aircraft to in a horizontal direction along the longitudinal axis. As a further non-limiting example, pusher component may twist and/or rotate to pull air behind it and, at the same time, push aircraft 100 forward with an equal amount of force. In an embodiment, and without limitation, the more air forced behind aircraft, the greater the thrust force with which aircraft 100 is pushed horizontally will be. In another embodiment, and without limitation, forward thrust may force aircraft 100 through the medium of relative air. Additionally or alternatively, plurality of flight components 108 may include one or more puller components. As used in this disclosure a “puller component” is a component that pulls and/or tows an aircraft through a medium. As a non-limiting example, puller component may include a flight component such as a puller propeller, a puller motor, a tractor propeller, a puller propulsor, and the like. Additionally, or alternatively, puller component may include a plurality of puller flight components.

Still referring to FIG. 1, aircraft 100 may have a flight controller. As used in this disclosure a “flight controller” is a computing device of a plurality of computing devices dedicated to data storage, security, distribution of traffic for load balancing, and flight instruction. Computing device may include and/or communicate with any other computing device as described in this disclosure, including without limitation a microcontroller, microprocessor, digital signal processor (DSP) and/or system on a chip (SoC) as described in this disclosure. Further, computing device may include a single computing device operating independently, or may include two or more computing device operating in concert, in parallel, sequentially or the like; two or more computing devices may be included together in a single computing device or in two or more computing devices. In embodiments, computing device may be installed in an aircraft, may control the aircraft remotely, and/or may include an element installed in the aircraft and a remote element in communication therewith.

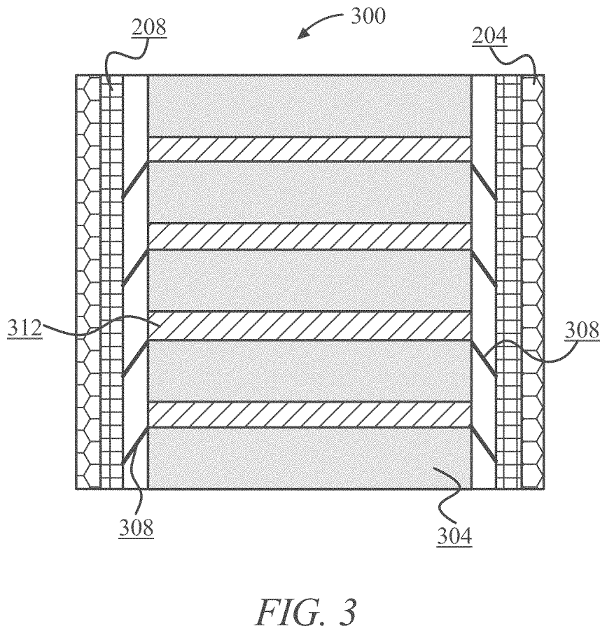

Now, referring to FIG. 2, system 200 illustrates a diagrammatic representation of an exemplary embodiment of the case. The system includes exterior surface 204 of the case, interior surface 208, opening 212, lip 216, and hole 220. In this embodiment, the term “case” refers to a container designed to hold or protect something; in this case, the case is holding and protecting the plurality of battery cells, which is described further herein with reference to FIG. 3. In some cases, case 200 may be made from metal for example one or more of sheet metal, stamped metal, extruded metal, and/or machined metal. In some cases, case 200 may be formed by way of welding, brazing, and/or soldering. In some cases, case 200 may be composed wholly or in part of a relatively light and strong metal, such as without limitation aluminum alloy. As shown in FIG. 1, case 200, may include an exterior surface 204 and interior surface 208 that are curated from different materials, and are explained further below. In some versions, case may provide a firewall between flammable battery modules within the battery and an environment or vehicle surrounding the battery.

Still referring to FIG. 2, case 200 includes an exterior surface 204. In this disclosure, “exterior surface” is the surface on the outside of the case that protects the layers of battery cells on the inside. Exterior surface 204 may be made from any of the materials above. A possible material the exterior surface may be composed of, without limitation, is nickel-coated steel; this material works well with lithium-ion batteries due to the corrosion protection and chemical resistance provided by the nickel. Additionally, exterior surface 204 may not be thermally conductive so it may contain the electric charge within the casing and avoid any sort of injury to a worker.

Still referring to FIG. 2, case 200 includes an interior surface 208. In this disclosure, the “interior surface” is the surface on the inside of the case that comes into contact with the layer of the plurality of battery cells. Interior surface 208 may include of any adonized material. In this disclosure, anodized means that the object is coated in a protective oxide layer through an electrochemical process. The purpose of anodizing a material is to increase its thermal conductivity, corrosion resistance, and abrasion resistance. Adonizing the interior surface 208 of the case allows for the mitigation of charge buildup and avoids storing energy at a high voltage. Examples of adonized materials that interior surface 208 may be composed of are aluminum, aluminum alloys, magnesium, titanium, and the like. It is important to note that the interior surface 208 and exterior surface 204 of the case are made from different materials and are explained further herein with reference to FIG. 3.

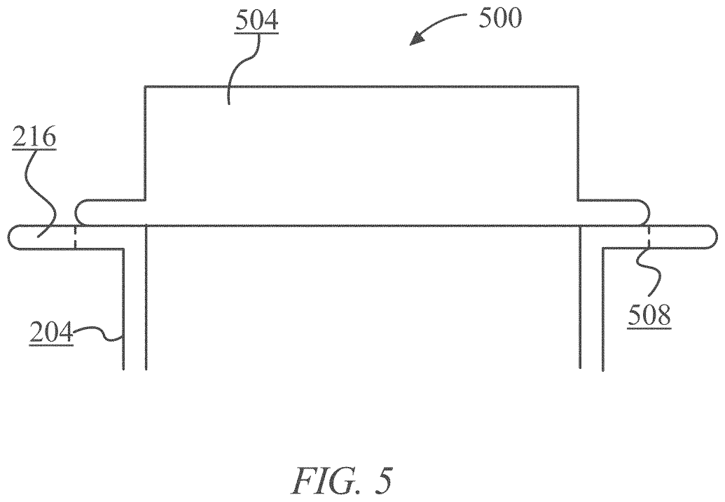

Still referring to FIG. 2, case 200 includes opening 212. Opening 212 may be located anywhere on the case, but the exemplary embodiment illustrates the opening at the top of the case. In this disclosure, an “opening” is a hole on the case that allows the layer of battery cells to be place inside and also allows a lid to be secured to it. The main purpose of the opening may be to have an entrance and exit for the installation and removal of the layers of battery cells. Lid is further described herein with reference to FIG. 5. Examples of opening 212 may be the entire top surface of the case missing to become a hole, as seen in FIG. 1., or a side surface could be removed and become opening 212 on the case. Only one opening 212 may be needed, but more may be placed on the case 200 if necessary. Opening 212 has a different function than hole 220, which is explained further below. Opening 212 is discussed more herein with reference the lid in FIG. 5.

Still referring to FIG. 2, case 200 includes lip 216. In this disclosure, “lip” is an edge that projects out of opening 212 of case 200 wherein the lid of the case may rest on it without falling into the case. Lip 216 may include a longer side and a shorter side. Lip 216 may also include a flange on its longer side to attach the lid to the case. In this embodiment, a “flange” is a piece of the lip that serves to stabilize the lid to the case. There may be at least one lip 216 attached to the opening but there may be any amount; more lips mean more flanges to lock lid into place. Lip 216 and its flange are described further herein with reference to FIG. 5.

Still referring to FIG. 2, case 200 may include hole 220. More than one hole 220 may be cut into case 200 if needed. In this embodiment, hole 220 serves as a cutout located on the outside of the case. Hole 220 may not be as large as opening 212 and may not be covered with a lid. The purpose of hole 220, or holes, may be to vent hot gases out of the case to reduce the temperature and voltage inside the case. In some embodiments, the cutouts may be covered by a material to stop the ventilation and to stop any foreign materials from entering the case, but the materials must be heat resistant, so the hot gases do not melt it. Hole or holes 220 are not needed to for the system 200 but are useful to help cool and ventilate the case.

Now referring to FIG. 3, an exemplary embodiment of the layers of the plurality of battery cells is illustrated. The system 300 comprises of a plurality of layering of the following: battery cell 304, fin 308, insulation layer 312, interior surface 208, and exterior surface 204. In this disclosure, “layers” refers to the method of stacking the plurality of battery cells on top of each other when placing them into the case.

Still referring to FIG. 3, system 300 includes a plurality of battery cells 304. A first plurality of battery cells may include lithium-ion battery cells. A first plurality of battery cells may include pouch cells. In some embodiments, a battery cell of a first plurality of battery cells may include a flexible casing. A “battery cell” as used in this disclosure, is an electrochemical element that holds an electric potential. In some embodiments, plurality of battery cells 304 may be lithium-ion pouch cells. In some embodiments, battery pack may be configured to hold 16 battery cells. In some embodiments, battery pack may be configured to include any number of battery cells. In other embodiments, battery pack may be configured to hold more or less than 16 battery cells. Battery cells 304 in the battery pack may be electrically configured to connect to one another. In one embodiment, battery cells 304 may have an insulating barrier. In some embodiments, battery cells 304 may be configured in series and/or in parallel. In some embodiments, battery cells 304 may be positioned in one row in the battery pack. In other embodiments, battery cells 304 may be positioned in multiple rows in the battery pack. In some embodiments, battery cells 304 may be in a staggered arrangement in battery pack. In some embodiments, a battery assembly may be configured to include an electrical bridging device. An electrical bridging device may include a cooling element. In some embodiments, an electrical bridging device may be configured to carry an electrical current. In some embodiments, an electrical bridging device may be configured to be housed inside a plurality of battery cells. In some embodiments, a top of each battery cell of a plurality of battery cells may be coupled to a first side of an electrical bridging device. In some embodiments, a top of each battery cell of a plurality of battery cells may be coupled to another side of an electrical bridging device.

In some embodiments and still referring to FIG. 3, battery cells 304 may be disposed and/or arranged within a respective battery pack in groupings of any number of columns and rows. In some embodiments, any two adjacent rows of battery cells 304 may be offset by a distance equal to a width or length of a battery cell 304. This arrangement of battery cells 304 is only a non-limiting example and in no way precludes other arrangement of battery cells. In some embodiments, battery cells 304 may be fixed in position by a battery cell retainer. Battery cells 304 may each include a cell configured to include an electrochemical reaction that produces electrical energy sufficient to power at least a portion of an electric aircraft. In some embodiments, battery cells 304 may be electrically connected in series, in parallel, or a combination of series and parallel. Series connection, as used herein, includes wiring a first terminal of a first cell to a second terminal of a second cell and further configured to include a single conductive path for electricity to flow while maintaining the same current (measured in Amperes) through any component in the circuit. Battery cells 304 may use the term ‘wired’, but one of ordinary skill in the art would appreciate that this term is synonymous with ‘electrically connected’, and that there are many ways to couple electrical elements like battery cells 304 together. As an example, battery cells 304 may be coupled via prefabricated terminals of a first gender that mate with a second terminal with a second gender. Parallel connection, as used herein, includes wiring a first and second terminal of a first battery cell to a first and second terminal of a second battery cell and further configured to include more than one conductive path for electricity to flow while maintaining the same voltage (measured in Volts) across any component in the circuit. Battery cells 304 may be wired in a series-parallel circuit which combines characteristics of the constituent circuit types to this combination circuit. Battery cells 304 may be electrically connected in any arrangement which may confer onto the system the electrical advantages associated with that arrangement such as high-voltage applications, high-current applications, or the like. In some embodiments, battery cell retainer may employ a staggered arrangement to allow more battery cells to be disposed closer together than in columns and rows like in a grid pattern. A staggered arrangement may also be configured to allow better thermodynamic dissipation. In other embodiments, cell retainer may hold battery cells 304 in a square or grid-like pattern.

Still referring to FIG. 3, system 300 includes a layer of insulation 312 between each later of battery cells 304. In this disclosure, “insulation layer” is the layer of thermal insulation separating the layers of plurality of battery cells. Insulation layer 312 will be compressed, so the material from which it is made up of must withstand the expected pressure from the compressed case; the case applies a pressure within a range of 2-5 pounds per square inch (PSI) (1.4-3.4 kPa) to the layers of insulation and layers of plurality of battery cells. For example, using the spring constant of the material as a metric of interest, the spring constant of the material should be non-negligible. In this disclosure, the spring constant is the force needed to stretch or press a spring. In some embodiments, the material may be aerogel since it is a good thermal insulator and has a non-negligible spring constant. Insulation layer 312 prevents heat from spreading from one cell to another. Without any insulation, if a battery cell fails and releases catastrophic amounts of heat, then the whole battery will fail and cause catastrophic damage to the aircraft.

Still referring to FIG. 3, system 300 includes a thermally conducting fin 308 contacting the thermally conducting interior surface 208. In this disclosure, a thermally conducting fin is a small piece of thermally conducting material that contacts the insulation layer and the interior surface of the can. As used in this disclosure, a “thermally conducting” material is a material that has a high thermal conductivity as the term is understood to mean for persons in the battery/battery management line of work. Most materials considered thermally conductive have a thermal conductivity within the range of 10 or more watts per kelvin-meter; a highly thermally conductive material may have a thermal conductivity of greater than 200 watts per kelvin-meter. Example materials include, without limitation, silver, copper, aluminum, iron, titanium, or even diamond which has an extremely high thermal conductivity. Thermally conducting fin 308 includes a spring force that pushes it towards the anodized interior surface of the can. Fin 308 include a plurality of independent sections wherein each section has an independent spring force that independently pushed that section of the fin towards the adonized interior surface. In this disclosure, spring force is the force exerted by a compressed or stretched spring upon an object that may be attached to it. Fin 308 maybe made out of any material that may contain a spring force, such as elastic, spring steel, or the like. Fin 308 must also be made out of a conductive material so that the thermally conductive layer with the fins can conduct heat away from the cell. Fin 308 may be any shape or size as long as it is still contacting both surfaces. Additionally, inserting the system into case 200 may elastically deform thermally conducting fin 308, causing it to exert an elastic recoil force, such as without limitation a recoil force as indicated by Hooke's law.

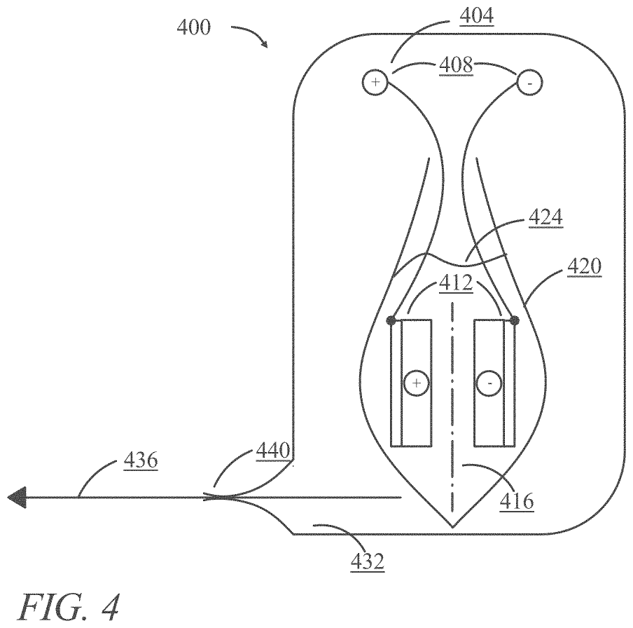

Referring still to FIG. 3, system 300 includes a pouch cell within the battery cells 304. As used in this disclosure, “pouch cell” is a battery cell or module that includes a pouch. In some cases, a pouch cell may include or be referred to as a prismatic pouch cell, for example when an overall shape of pouch may be prismatic. In some cases, a pouch cell may include a pouch, which is further described herein with reference to FIG. 4. Pouch cell 404 may include without limitation a battery cell using nickel-based chemistries such as nickel cadmium or nickel metal hydride, a battery cell using lithium-ion battery chemistries such as a nickel cobalt aluminum (NCA), nickel manganese cobalt (NMC), lithium iron phosphate (LiFePO4), lithium cobalt oxide (LCO), lithium manganese oxide (LMO), a battery cell using lithium polymer technology, and/or metal-air batteries. Pouch cell 404 may include lead-based batteries such as without limitation lead acid batteries and lead carbon batteries. Pouch cell 404 may include lithium sulfur batteries, magnesium ion batteries, and/or sodium ion batteries. Pouch cell 404 may include solid state batteries or supercapacitors or another suitable energy source. In other embodiments, the pouch cell may be a prismatic, cylindrical, or other type of battery cell. In some embodiments, the pouch cell may be a lithium-ion battery. In some embodiments, the lithium-ion battery may include lithium-ion battery chemistries such as a nickel cobalt aluminum (NCA), nickel manganese cobalt (NMC), lithium iron phosphate (LiFePO4), lithium cobalt oxide (LCO), and/or lithium manganese oxide (LMO). Persons skilled in the art, upon reviewing the entirety of this disclosure, will be aware of various devices of components that may be used as a pouch cell.

Referring now to FIG. 4, a pouch cell 404 is illustrated. Pouch cell includes a pair of electrodes 408, pair of foil tabs 412, insulation layer 416, pouch 420, electrolyte 424, ejecta barrier 428, vent 432, flow path 436, and valve 440. Pouch cell 404 may include any pouch cell as described in this disclosure.

Still referring to FIG. 4, pouch cell 404 may include a pair of electrodes 408. In this disclosure, a pair of electrodes is a conductor through which electricity enters or leaves an object, and in this case the object is pouch cell 404. In some embodiments, conductive foil tabs may be electrically connected to electrodes located inside a pouch cell 404. Electrodes 408 may include a positive electrode and a negative electrode. Each electrode of may include an electrically conductive element. Non-limiting exemplary electrically conductive elements include braided wire, solid wire, metallic foil, circuitry, such as printed circuit boards, and the like. Electrodes 408 may be in electric communication with a pair of foil tabs. Electrodes 408 may be bonded in electric communication with pair of foil tabs by any known method, including without limitation welding, brazing, soldering, adhering, engineering fits, electrical connectors, and the like.

Still referring to FIG. 4, pouch cell 404 may include a pair of foil tabs 412 in electrical communication with the electrodes 408. In this disclosure, pair of foil tabs 412 are tabs that protrude from the battery which allows the cells energy to be transferred to an external source. Conductive foils tabs 412 may be configured to carry positive and negative terminals to an outside of a battery cell of a first plurality of battery cells. In some embodiments, conductive foil tabs may be wielded to an outside of a battery cell. In some cases, pair of foil tabs 412 may include a cathode and an anode. In some cases, an exemplary cathode may include a lithium-based substance, such as lithium-metal oxide, bonded to an aluminum foil tab. In some cases, an exemplary anode may include a carbon-based substance, such as graphite, bonded to a copper tab. In some embodiments, an anode may be double sided. In some embodiments, a cathode may be double sided. In some embodiments, an anode and a cathode may be stacked and wrapped in a separator. In some embodiments, an anode, cathode, and separator may be stacked and wrapped in a z-fold pattern. In other embodiments, an anode, cathode, and separator may be stacked and wrapped in a rectangular, square, or other pattern. In some embodiments, a cathode and an anode may be welded together, placing them in a series connection. In one embodiment, a cathode and an anode may be welded ultrasonically. In some embodiments, a cathode and an anode may be further welded to pair of foil tabs 412. Pair of foil tabs 412 may be sealed to an outside portion of battery cell. An “outside portion” as used in this disclosure may be an exterior surface of an object. An outside portion may be included in a first plurality of battery cells and/or a second plurality of battery cells. In some embodiments, pair of foil tabs 412 may be configured to connect to an external load or power source. In some embodiments, pair of foil tabs 412 may be configured to power an electric aircraft. In some embodiments, an electric aircraft may be an electric vertical takeoff and landing vehicle (“eVTOL”).

Still referring to FIG. 4, pouch cell 404 may include an insulator layer 416 located substantially between the at least a pair of foil tabs 412. As used in this disclosure, an “insulator layer” is an electrically insulating material that is substantially permeable to battery ions, such as without limitation lithium ions. In some cases, insulator layer may be referred to as a separator layer or simply separator. In some cases, insulator 416 may be configured to prevent electrical communication directly between pair of foil tabs 412 (e.g., cathode and anode). In some cases, insulator layer 416 may be configured to allow for a flow ions across it. Insulation layer 416 may include a polymer, for example polyolifine (PO). Insulation layer 416 may include pours which are configured to allow for passage of ions, for example lithium ions. In some cases, pours of a PO separator may have a width no greater than 100 μm, 10 μm, 1 μm, or 0.1 μm. In some cases, a PO separator may have a thickness within a range of 1-100 μm, or 10-50 μm.

Still referring to FIG. 4, pouch cell 404 may include a pouch 420 substantially encompassing the at least a pair of foil tabs 412 and at least a portion of the at least a separator layer 416. In this disclosure, pouch may be a small, flexible bag that holds the pair of foil tabs 412 and insulation layer 412. Pouch 420 may be substantially flexible. Alternatively or additionally, in some cases, a pouch 304 may be substantially rigid. In some cases, pouch 304 may include a polymer, such as without limitation polyethylene, acrylic, polyester, and the like. In some case, pouch 304 may be coated with one or more coatings. For example, in some cases, pouch 304 may have an outer surface. In some embodiments, the outer surface may be coated with a metalizing coating, such as an aluminum or nickel containing coating. In some cases, pouch coating be configured to electrically ground and/or isolate pouch, increase pouches impermeability, increase pouches resistance to high temperatures, increases pouches thermal resistance (po), and the like.

Still referring to FIG. 4, pouch cell 404 may include and an electrolyte 424 within the pouch 420. An electrolyte may be located in pouch 420. In this disclosure, electrolyte is chemical medium that allows the flow of electrical charge between the cathode and anode of the pair of foil tabs 412. In some cases, the electrolyte may include a liquid, a solid, a gel, a paste, and/or a polymer. In some embodiments, the electrolyte may be a lithium salt such as LiPF6. In some embodiments, the lithium salt may be lithium hexafluorophosphate, lithium tetrafluoroborate, lithium perchlorate, or other lithium salts. In some embodiments, the lithium salt may be in an organic solvent. In some embodiments, the organic solvent may be ethylene carbonate, dimethyl carbonate, diethyl carbonate or other organic solvents. In some embodiments, the electrolyte may wet or contact one or both of at least a pair of foil tabs

Still referring to FIG. 4, pouch cell 404 may include an ejecta barrier 428. As used in this disclosure, an “ejecta barrier” is any material or structure that is configured to substantially block, contain, or otherwise prevent passage of cell ejecta. For example, ejecta barrier 428 may substantially encapsulate pouch cell 404. As used in this disclosure, “ejecta” may be any material that has been ejected, for example from a battery cell. In some cases, cell ejecta may be ejected during thermal runaway of a battery cell. Alternatively or additionally, in some cases, cell ejecta may be ejected without thermal runaway of a battery cell. In some cases, cell ejecta may include lithium-based compounds. Alternatively or additionally, cell ejecta may include carbon-based compounds, such as without limitation carbonate esters. Cell ejecta may include matter in any phase or form, including solid, liquid, gas, vapor, and the like. In some cases, cell ejecta may undergo a phase change, for example, and without limitation, cell ejecta may be vaporous as it is initially being ejected and then cool and condense into a solid or liquid after ejection. In an embodiment, and without limitation, ejecta barrier 428 may be configured to prevent materials ejected from pouch cell 404 from coming into contact with other pouch cells. For example, and without limitation, ejecta barrier 428 may be substantially impermeable to cell ejecta from pouch cell 104 and/or one or more additional pouch cells. In some embodiments, ejecta barrier 428 may include titanium. As used in this disclosure “substantially impermeable” may be a characteristic of ejecta barrier that denotes the barrier prevents passage of one or more gases, fluids, and/or solids. In an embodiment, and without limitation, substantially impermeable may include a barrier being fully impermeable. For example, and without limitation, ejecta barrier 428 may be fully impermeable as a function of restricting and/or preventing all passage of cell ejecta across a barrier. As a further non-limiting example, ejecta barrier 428 may be impermeable as a function of blocking and/or halting all passage of cell ejecta across a barrier. In an embodiment, and without limitation, substantially impermeable may include ejecta barrier 428 being selectively impermeable, wherein a magnitude and/or percentage of cell ejecta may be allowed to pass and/or permeate ejecta barrier 428. For example, and without limitation, ejecta barrier 428 may be selectively impermeable for a fluid as a function of allowing 20% of a fluid to permeate, wherein ejecta barrier 428 may be impermeable to a gas such as carbon monoxide, wherein no carbon monoxide may permeate ejecta barrier 428.

Still referring to FIG. 4, ejecta barrier 428 may include a carbon fiber element. As used in this disclosure a “carbon fiber element” is a barrier comprising an element of carbon. For example and without limitation, carbon fiber element may include one or more carbon fiber sheets, carbon fiber supported metals, carbon fiber bands, and the like thereof. In an embodiment, and without limitation, carbon fiber element may include one or more carbon fibers comprising 5-10 micrometers in diameter. In another embodiment, and without limitation, carbon fiber element may include high stiffness, high tensile strength, low weight to strength ratio, high chemical resistance, high temperature tolerance, and/or low thermal expansion. In an embodiment, and without limitation, carbon fiber element may include one or more composites such as a plastic resin, polymer, graphite, and the like thereof. In some cases, ejecta barrier 428 may include at least a one of a lithophilic or a lithophobic material or layer, configured to absorb and/or repel lithium-based compounds. In some cases, ejecta barrier 428 may include a lithophilic metal coating, such as silver or gold. In some cases, ejecta barrier 428 may be flexible and/or rigid. In some cases, ejecta barrier 428 may include a sheet, a film, a foil, or the like. For example in some cases, ejecta barrier 428 may be between 25 and 5,000 micrometers thick. In some cases, ejecta barrier 428 may have a nominal thickness of about 2 mm. Alternatively or additionally, in some cases, ejecta barrier 428 may include rigid and/or structural elements, for instance which are solid. Rigid ejecta barriers 428 may include metals, composites and the like. In some cases, ejecta barrier 428 may be further configured to structurally support pouch cell 404. For example in some cases, pouch cell 404 may be mounted to a rigid ejecta barrier 428. Ejecta barrier 428 may configured to prevent ejecta from one pouch cell 404 from reaching another pouch cell. In some cases, ejecta may include hot matter, which if left uncontained could transfer heat to other, e.g., neighboring, pouch cells. By preventing hot ejecta from reaching pouch cells ejecta barrier 428 may aid in preventing progression of thermal runaway between battery cells within pouch cell 404. In some cases, ejecta may include combustible materials, which if left uncontained could settle upon other, e.g., neighboring, pouch cells. Combustible materials once combustion conditions are met may combust generating an exothermic reaction, which can induce thermal runaway on nearby battery cells. Combustion conditions can include presence of oxygen, fuel, spark, flash point, fire point, and/or autoignition temperature.

Still referring to FIG. 4, pouch cell 404 may include a vent 432. Vent 432 may provide for ejecta flow along a flow path 436. In some cases, vent 432 may be configured to vent cell ejecta from pouch cell 404. In some cases, at least a vent 432 may be configured to vent cell ejecta along a flow path 436. For example fluids such as gases liquids, or any material that acts as a gas or liquid, flowing along the flow path 436 may be cordoned away from contact with pouch cell 404. For example flow path 436 may be configured to not intersect with any surface of pouch cell 404. As a further non-limiting example, flow path 436 may be configured to extend from pouch cell 404 to an exterior location. As used in this disclosure an “exterior location” is a location and/or place that exists outside of stack battery pack. In an embodiment, and without limitation, exterior location may include a location and/or place that exists outside of an aircraft, wherein an aircraft is described below, in reference to FIG. 1. Flow path 436 may include any channel, tube, hose, conduit, or the like suitable for facilitating fluidic communication, for example with a pouch cell. In some cases, flow path 436 may include check valve 440. As used in this disclosure, a “check valve” is a valve that permits flow of a fluid only in certain, for example one, direction. In some cases check valve 440 may be configured to allow flow of fluids substantially only away from pouch cell 404 while preventing back flow of vented fluid to pouch cell 404. In some cases, check valve 440 may include a duckbill check valve. In some cases, a duckbill check valve may have lips which are substantially in a shape of a duckbill. Lips may be configured to open to allow forward flow (out of the lips), while remaining normally closed to prevent backflow (into the lips). In some cases, duckbill lips may be configured to automatically close (remain normally closed), for example with use of a compliant element, such as without limitation an elastomeric material, a spring, and the like. In some embodiments vent may include a mushroom poppet valve. In some cases, a mushroom poppet valve may include a mushroom shaped poppet. Mushroom shaped poppet may seal against a sealing element, for example a ring about an underside of a cap of the mushroom shaped poppet. In some cases, mushroom poppet valve may be loaded against sealing element, for example by way of a compliant element, such as a spring. According to some embodiments, vent 160 may have a vacuum applied to aid in venting of cell ejecta. Vacuum pressure differential may range from 0.1″Hg to 36″Hg. In some cases, vent 432 may be configured to provide fluidic communication through at least one of ejecta barrier 428 and/or pouch 420. In some cases, vent 432 may include a seam. Seam may be a seam of pouch 420. Alternatively or additionally; seam may be a seam of ejecta barrier 428. Vent may include a check valve 440. Check valve 440 may be configured to allow for a flow fluids in substantially one direction, for example away from pouch cell 404. In some cases, vent 432 may be configured to allow for a venting of ejecta from pouch cell 404 without substantially any flow of ejecta toward the pouch cell 404, for example from other battery cells.

Now referring to FIG. 5, system 500 includes a diagram showing a possible embodiment of the lid of the case 200. System 500 includes lid 504, lip 216, flange 508, and exterior surface 204.

Still referring to FIG. 5, system 500 includes lid 504 that rests on top of lip 216. In this disclosure, lid is a removable cover to cover the opening of the case. The underside of the lid may be made of the same material as the interior, while the rest may be made with the non-anodized material of the exterior surface. Lid 504 may be configured to cover the opening of the case where the flange may be configured to wrap around the lid when it is covering the opening of the can, the flange is further described below. Lid 504 may be configured to leave no gap or space between itself, and the case, so not hot gases or toxins escape that could possibly cause harm to the aircraft or its workers. Lid 504 is configured to rest on lip 216, which is described herein with reference to FIG. 2. Lid 504 may not be usually placed on top of the case until the entirety of plurality of battery cells, insulation layers, and fins have been inserted into the case. Lid 504 could also be known as the “top side” of the case, as seen missing in FIG. 2. In a nonlimiting example, the top side may be a lid with electric terminals designed to connect the battery cells attached to the terminals. In another nonlimiting example, the terminals may include a sensor designed to monitor the status of the battery cells connected to the terminals.

Still referring to FIG. 5, system 500 includes lip 216 which includes flange 508. In this disclosure, a flange is a projecting flat rim, collar, or rib on an object, serving to strengthen or attach or (on a wheel) to maintain position. Flange 508 more securely fastens the lid the top of the case by wrapping around the lid. it further helps prevents hot gases or toxins from escaping through a gap between the lid and the case. It is important to note that flange 508 may be located on the longer side of lip 216, which is usually weaker than the shorter side where hot gases and toxins are more likely to escape. Since the longer side is weaker, flange 508 may be placed there to strengthen it. Flange 508 may not be needed on the shorter sides because gas and toxins are less likely to escape there. Flange 508 may also include any sort of fastener or adhesive, including but without limitation, glue, nails, bolts, screws, lap joint flanges, or the like. Flange 508 may be made with the same material as the exterior surface of the case. However, material must not be brittle enough as to where flange 508 may easily break off when it is being wrapped around lid 504. To prevent flange 508 form breaking off, it may not be anodized. In some applications, the thickness of the anodization layer must be paid attention to, or this material may be too brittle or may not offer the desires electrical insulation.

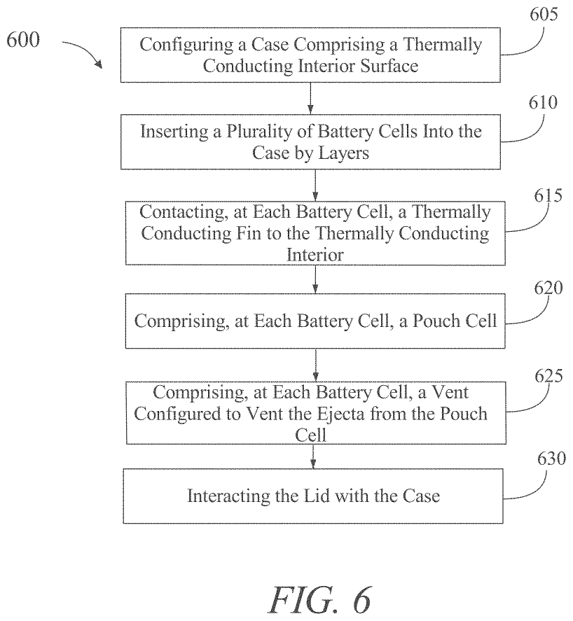

Now referring to FIG. 6, an exemplary embodiment of method 600 for a battery system with spring conductors of an electric aircraft. The electric aircraft may include, without limitation, any of the aircraft as disclosed herein and described above with reference to at least FIG. 1, including an eVTOL aircraft.

Still referring to FIG. 6, at step 605, method 600 includes configuring a case 200 comprising a thermally conducting interior surface 208. The thermally conducting interior surface of the case is anodized. The case includes a lip around an opening. The lip includes a shorter side and a longer side. The case may include, without limitation, any of the cases as disclosed herein and described above with reference to at least FIG. 2. The interior surface may include, without limitation, any of the interior surfaces as disclosed herein and described above with reference to at least FIG. 2.

Still referring to FIG. 6, at step 610, method 600 includes inserting a plurality of battery cells 304 into the case by layers. The case applies a pressure within a range of 2-5 PSI to the layers of the plurality of battery cells. Between each layer of battery cells is a layer of thermal insulation. The plurality of battery cells may include, without limitation, any of the battery cells as disclosed herein and described above with reference to at least FIG. 3.

Still referring to FIG. 6, at step 615, method 600 includes contacting, at the battery cell, a thermally conducting fin to the thermally conducting interior. Thermally conducting fin comprises a spring force that pushes it towards the anodized interior surface of the can. The plurality of battery cells may include, without limitation, any of the battery cells as disclosed herein and described above with reference to at least FIG. 3. The thermally conducting fin may include, without limitation, any of the fins as disclosed herein and described above with reference to at least FIG. 3. The interior surface may include, without limitation, any of the interior surfaces as disclosed herein and described above with reference to at least FIG. 2.

Still referring to FIG. 6, at step 620, method 600 includes comprising, at the battery cell, pouch cell 404. Pouch cell 404 includes a pair of electrodes, a pair of foil tabs electrically connected to the electrodes, an insulator layer located between the pair of foil tabs, a pouch encompassing the pair of foil tabs and the insulation layer, and an electrolyte within the pouch. The plurality of battery cells may include, without limitation, any of the battery cells as disclosed herein and described above with reference to at least FIG. 3. The pouch cell may include, without limitation, any of the pouch cells as disclosed herein and described above with reference to at least FIGS. 3-4.

Still referring to FIG. 6, at step 625, method 600 includes comprising, at the battery cell, a vent configured to vent the ejecta from the pouch cell. The plurality of battery cells may include, without limitation, any of the battery cells as disclosed herein and described above with reference to at least FIG. 3. The vent may include, without limitation, any of the vents as disclosed herein and described above with reference to at least FIG. 4.

Still referring to FIG. 6, at step 630, method 600 includes interacting the lid with the case. The lid rests on the lip of the case, which includes a flange. Flange is located on the longer side of the lip. Flange is not adonized and is configured to wrap around the lid when the lid covers the opening of the case. The lid may include, without limitation, any of the lids as disclosed herein and described above with reference to at least FIG. 5. The case may include, without limitation, any of the cases as disclosed herein and described above with reference to at least FIG. 2.

1. An electric aircraft battery system with spring conductors, the battery system comprising:
a case, wherein the case comprises a thermally conducting interior surface;
a plurality of battery cells inserted into the case by layers, wherein each battery cell comprises:
a thermally conducting fin contacting the thermally conducting interior;
a pouch cell, wherein the pouch cell comprises:
a pair of electrodes;
a pair of foil tabs electrically connected to the electrodes;
an insulator layer located between the pair of foil tabs;
a pouch encompassing the pair of foil tabs and the insulation layer; and
an electrolyte within the pouch; and
an ejecta barrier configured to prevent material ejected from the pouch cell from coming into contact with other pouch cells; and
a vent configured to vent the ejecta from the pouch cell; and
a lid, wherein the lid is configured to interact with the case.

2. The system of claim 1, wherein the thermally conducting interior surface of the case is anodized.

3. The system of claim 1, wherein the case includes a lip around an opening.

4. The system of claim 1, wherein the lip includes a shorter side and a longer side.

5. The system of claim 3, wherein a flange is located on the longer side of the lip.

6. The system of claim 1, wherein the flange is configured to wrap around the lid when the lid covers the opening of the case.

7. The system of claim 1, wherein the flange is not anodized.

8. The system of claim 1, wherein the thermally conducting fin exerts a spring force that pushes it towards the anodized interior surface of the can.

9. The system of claim 1, wherein the case applies a pressure within a range of 2-5 pound-force per square inch (lbf/in²) to the layers of the plurality of battery cells.

10. The system of claim 1, wherein between each layer of battery cells is a layer of thermal insulation.

11. A method for a battery system with spring conductors of an electric aircraft, the method comprising:
configuring a case comprising a thermally conducting interior surface;
inserting a plurality of battery cells into the case by layers;
contacting, at the battery cell, a thermally conducting fin to the thermally conducting interior;
comprising, at the battery cell, a pouch cell wherein the pouch cell comprises:
a pair of electrodes;
a pair of foil tabs electrically connected to the electrodes;
an insulator layer located between the pair of foil tabs;
a pouch encompassing the pair of foil tabs and the insulation layer; and
an electrolyte within the pouch.
comprising, at the battery cell, a vent configured to vent the ejecta from the pouch cell;
interacting the lid with the case.

12. The method of claim 11, wherein the thermally conducting interior surface of the case is anodized.

13. The method of claim 11, wherein the case includes a lip around an opening.

14. The method of claim 11, wherein the lip includes a shorter side and a longer side.

15. The method of claim 13, wherein a flange is located on the longer side of the lip.

16. The method of claim 11, wherein the flange is configured to wrap around the lid when the lid covers the opening of the case.

17. The method of claim 11, wherein the flange is not anodized.

18. The method of claim 11, wherein the thermally conducting fin comprises a spring force that pushes it towards the anodized interior surface of the can.

19. The method of claim 11, wherein the case applies a pressure within a range of 2-5 pounds per square inch to the layers of the plurality of battery cells.

20. The method of claim 11, wherein between each layer of battery cells is a layer of thermal insulation.
